(19) United States
(12) Patent Application Publication
(10) Pub. No.: US 2005/0239945 A1
(43) Pub. Date: Oct. 27, 2005

(54) Method of producting modified metal oxides that are dispersible in an organic matrix

(76) Inventors: Thomas J. Martin, Tulsa County, OK (US); April J. Arthur, Travis County, TX (US)

Correspondence Address: Browning Bushman P.C., 5718 Westheimer, Suite 1800, Houston, TX, 77057, US

(21) Appl. No.: 10/831,827

(22) Filed: Apr. 26, 2004

(51) Int. Cl. C09K 3/00; B01F 3/12

(52) U.S. Cl. 524/492; 524/1; 516/78

(57) ABSTRACT

A method of preparing a metal oxide which is dispersible in organic matrices such as apolar organic liquids wherein a product mixture is formed by adding sol of the metal oxide to an aqueous suspension of a sulfonic acid modifier, the modified metal oxide being recovered from the product mixture

### BACKGROUND OF THE INVENTION

1. Field of the Invention

The present invention relates to the preparation of modified metal oxides which are dispersible in organic matrices.

2. Description of the Prior Art

Recently there has been an emphasis on the production of modified metal oxides such as aluminas to render the metal oxides dispersible in various organic matrices, e.g., polymers, organic liquids and the like. The prior art discloses methods to prepare metal oxides which are dispersible in aqueous mediums and polar organic liquids. See in this regard, U.S. Pat. Nos. 4,676,928 and 6,224,846. While these dispersible metal oxides, e.g., aluminas, have a wide variety of uses, it clearly would be desirable to have metal oxides which are dispersible in organic matrices, as for example in apolar organic solvents. In particular, it would be desirable to have metal oxides that are dispersible in apolar organic solvents or liquids and that form stable sols.

U.S. Pat. No. 6,224,846 discloses modified aluminas which are dispersible in polar organic and/or aqueous media. PCT/DE00/02163 discloses a method for preparing metal oxides which are dispersible in organic solvents, the metal oxides being modified with organic sulfonic acids.

### SUMMARY OF THE INVENTION

In accordance with a preferred embodiment of the present invention, there is provided a method of preparing a metal oxide that is dispersible in an organic matrix. In the preferred embodiment there is formed a reaction product mixture by adding an aqueous sol of a metal oxide to an aqueous suspension of a sulfonic acid modifier having the structure
X(SO_{y})ₙM
wherein X is an organic moiety, M is a monovalent cation, y is 3 or 4, and n is an integer reflecting the number of —SO_{y}M groups bonded to the organic moiety, to produce a modified metal oxide. The modified metal oxide is recovered from the reaction product mixture and, preferably after drying, can be dispersed in various organic matrices, e.g., apolar organic liquids, to form stable organic sols of the metal oxides, or in organic matrices such as molten polymers to form nanocomposites wherein the modified metal oxide is uniformly dispersed throughout the matrix.

### DESCRIPTION OF THE PREFERRED EMBODIMENTS

The term “metal oxide”, as used herein, includes not only metal oxides per se but various hydrates thereof. The metal oxides which are useful in the present invention are those metal oxides which can be treated to form aqueous sols, i.e., stable aqueous dispersions, essentially colloidal in nature, of the metal oxide. Such oxides, when in the sol form, have a particle size of less than about one micron. Generally speaking, the particle size of the metal oxide in the aqueous sols will be from 1 to 500 nm, preferably from 5 to 50 nm. Generally, the metal oxides which are useful in the present invention include aluminas, e.g., boehmites, pseudoboehmites, various other forms of alumina, silica, mixed oxides of silicon and aluminum, aluminum silicate, etc. The preferred metal oxides are aluminas e.g. boehmite, pseudoboehmite, etc.

According to the present invention, an aqueous sol of the metal oxide is added to an aqueous dispersion of a sulfonic acid modifier described more fully hereafter. The term “aqueous sol” is intended to mean a dispersion of the metal oxide wherein the metal oxide remains suspended in the aqueous medium without any significant settling under quiescent conditions.

The amount of metal oxide in the aqueous sol can vary over wide limits but generally will be in the range of from about 1 to 15 wt. %, calculated as metal oxide.

Sulfonic acid compounds (modifiers) useful in the method of the present invention are those having the formula:
X(SO_{y})ₙM
wherein X is an organic moiety, M is a monovalent cation, y is 3 or 4, and n is an integer reflecting the number of —SO_{y}M groups bonded to the organic moiety. It will be recognized from the above formula that the type of sulfonic acid compounds employed in the process of the present invention can vary widely.

Non-limiting examples of suitable sulfonic acid modifiers covered by the above formula include alkyl sulfonic acids having the formula:
RSO_{y}M
wherein R is an organic group having from 1 to 16 carbon atoms; aryl sulfonic acids having the formula:
ArSO_{y}M
wherein Ar is an aryl group wherein the aryl group can be a phenyl group, a benzyl group, a tolyl group, a naphthyl group, or any other molecule containing an aromatic nucleus, including condensed six carbon rings, compounds such as phenanthrene, anthracene, etc.; metallo-organic compounds with sulfonic acid functionalities; polymers such as sulfonated styrene-butadiene copolymers, sulfonated fluorocarbons, etc.; sulfonated chiral species; and virtually any other sulfonated organic species that can be used to modify the boehmite alumina. Particularly preferred when making a dispersible modified alumina are sulfonic acid modifiers such as allyl sulfonic acids, including methane sulfonic acid, ethane sulfonic acid, and other alkyl or alkylaryl sulfonic acids, such as alkyl benzenesulfonic acids, aliphatic sulfonic acids, aryl sulfonic acids such as p-toluenesulfonic acid, phenol red. It will be appreciated that the alkyl sulfonic and aryl sulfonic acids and alkylaryl sulfonic acids include substituted alkyl and aryl sulfonic acids such as, for example, trifluoromethane sulfonic acid, phenol red, sulfonated xylenes, and other, more complex molecules, that contain sulfonic acid functionality but that are free of substituents or groups that would deleteriously affect the modification of the boehmite alumina to a modified boehmite alumina.

An especially preferred group of sulfonic acids modifiers are represented by the formula: 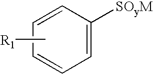
wherein R₁ is an organic moiety containing from 7 to 20 carbon atoms, preferably from 16 to 20 carbon atoms and R₁ can be substituted with other functional groups such as —OH, —NH₂, etc. and can be unsaturated. Especially preferred are compounds wherein R₁ is an alkyl group containing from 7 to 20 carbon atoms, preferably from 10 to 14 carbon atoms. The R group can have the same structure as the R₁ group, as described above.

As noted above, M is a monovalent cation, preferably hydrogen. However, M can also be sodium, potassium, lithium, etc, provided that such ions are not present in amounts that cause gelling.

As can be seen from the above with respect to the type of sulfonic acid modifiers that can be employed, the value of n and, more specifically, the sulfonic acid content of the sulfonic acid modifier can vary widely. For example, in the case of an alkyl sulfonic acid, such as methane sulfonic acid, the sulfonic acid content of the molecule on a weight basis is quite high. On the other hand, in the case of a sulfonated polymer, such as a sulfonated styrene butadiene polymer, the weight content of the sulfonic acid in the polymer might be relatively small, depending on the degree of sulfonation. Indeed, it is this wide disparity in the amount of the sulfonic acid present in the sulfonic acid modifier that allows for tailoring of the metal oxides to achieve a modified metal oxide with desired properties. In general, the sulfonic acid modifier can contain from as little as 5% by weight sulfonic acid to as much as 85% by weight sulfonic acid, calculated as —SO_{y}H.

The sulfonic acid modifier useful in the present invention must be of a type that forms a stable suspension or dispersion in an aqueous medium. The term “suspension” or “dispersion,” with respect to the sulfonic acid modifier, includes solutions, emulsions, colloidal dispersions, etc. In general, the dispersions will have the characteristic that there is no substantial settling of the sulfonic acid modifier from the aqueous medium under quiescent conditions.

The amount of sulfonic acid modifier in the aqueous dispersion can vary over wide limits but generally will be in the range of from about 0.02 to about 0.5 wt. %, calculated as —SO_{y}H.

According to a preferred mode of the present invention, the aqueous sol of the metal oxide is added to the aqueous suspension of the sulfonic acid modifier to provide a uniform mixture of the components. Generally speaking, the weight ratio of metal oxide, calculated as metal oxide, to sulfonic acid modifier, calculated as X(SO_{y})ₙM in the mixture is from 98:2 to 70:3. The mixing can be carried out at room temperature and, depending upon the particular metal oxide sol and/or sulfonic acid modifier, will produce a modified metal oxide which is dispersible in an organic matrix. Optionally, the mixture can be heated to a temperature of from 30 to 170° C. for 50 to 280 min., again depending upon the nature of the metal oxide and/or the sulfonic acid modifier.

After the modified metal oxide has been formed, which is indicated by formation of solids, e.g., a floc, the solids are separated from the reaction product mixture by centrifuging, decanting, filtering or any other technique which results in dewatering of the solid, modified metal oxide. The wet, modified metal oxide is then dried by any conventional means, e.g., oven drying, spray drying, etc. Indeed, drying is preferred as it leads to modified metal oxides which display enhanced dispersibility in organic matrices. Generally, the drying will be carried out at a temperature of from 80 to 120° C. for a period of time sufficient to remove substantially all free water.

The modified metal oxide produced by the process of the present invention can be uniformly dispersed in organic matrices to produce a wide variety of products such as nanocomposites, transparent or translucent dispersions of the modified metal oxides in apolar organic liquids, etc. The term “organic matrix,” as used herein, is intended to include any organic composition which is either fluid or can be converted into a fluid state such that the modified metal oxide can be uniformly dispersed therein. Non-limiting examples of such organic matrices include organic solvents, particularly apolar organic solvents, flowable, high viscosity resins or polymers, molten polymers, etc. A particularly preferred group of organic matrices comprise organic solvents or liquids and more particularly, aromatic organic liquids such as benzene, toluene, xylene, cumene, etc. A characteristic of the modified metal oxides of the present invention is that, because of their dispersibility, i.e., their non-agglomeration tendency, organic matrices containing uniform and high loadings of the modified metal oxides can be achieved. Indeed, organic matrices containing up to 40% by wt. of modified metal oxide can be produced. When the organic matrix is an apolar organic legend, the modified metal oxide will generally be present in an amount of from 1 to 20% by wt.

To more fully illustrate the present invention, the following nonlimiting examples are presented.

### EXAMPLE 1

Alumina sols were made up using various aluminas (pseudoboehmites). The sols were then added to aqueous solutions of the sulfonic acid modifier. The modified aluminas that were produced were recovered and spray dried at an inlet temperature of 220° C. and an outlet temperature of 100° C. with an air flow rate and sol feed rate adjusted to maintain the outlet temperature. The dried, modified aluminas were made up at 1-5% w/w levels in toluene followed by dilution with excess toluene for particle size measurement by light scattering. The results are shown in Table 1 below:

TABLE 1
Initial particle size before treatment of aqueous alumina sol,
and after treatment with sulfonic acid, redispersed in toluene

| | Alumina/ | | | wt. alumina | wt. sulfonic acid |
|---|---|---|---|---|---|
| Sample No. | sulfonic acid | In water | In toluene | (wt. water) | (wt. water) |
| 1 | Dispal | 123 | 181 | | |
| | 23A4/LAS | | | | |
| 2 | Dispal | 107 | 136 | 120 (380) | 32.9 (500) |
| | 23N4/LAS | | | | |
| 3 | Dispal | 107 | 198 | 120 (380) | 32.9 (500) |
| | 23N4/LAS | | | | |
| 4 | Catapal | 246 | 332 | 400 (4000) | 26.8 (400) |
| | 200/LAS | | | | |
| 5 | Dispal | 123 | 145 | 400 (4000) | 104.7 (400) |
| | 23A4/LAS | | | | |
| 6 | Catapal | 223 | 276 | 6.7 (50.1) | 0.48 (12.7) |
| | 200/LAS | | | | |
| 7 | Dispal | 107 | 165/211 | 6 (19) | 1.7 (25.2) |
| | 23N4/LAS | | | | |
| 8 | Dispal | 107 | 134/239 | 6 (19) | 1.7 (25.5) |
| | 23N4/LAS | | | | |
| 9 | Dispal | 147 | 675 | 205.2 (649.8) | 37.6 (150.6) |
| | 18N4/LAS | | | | |
| 10 | Catapal 200/LAS | 223 | 221 | 7 (50) | 0.7 (13) |
| | | nm | nm | g | g |

LAS linear alkylbenzene sulfonic acid, with alkyl group having (C₉-C₁₄ chain length, predominantly C₁₁-C₁₂ chain length.
Dispal is an alumina marketed by Sasol North America, Inc.
Catapal is an alumina marketed by Sasol North America, Inc.

As can be seen from the data in Table 1, with few exceptions, the particle size of the alumina in the alumina sols (water) is not markedly different from the particle size of the modified alumina in toluene (toluene sols). Further, in all cases shown in Table 1, the modified aluminas, up to a concentration of 5% w/w in toluene were stable sols and translucent to transparent, i.e., they had NTU values of less than 1,000 nm. NTU (Normal Turbidity Unit) is an art recognized measurement of turbidity.

### EXAMPLE 2

This example shows the particle size of various alumina forms, in water (sols) and, in the modified form, in toluene (sols). In all cases, a 5 g quantity of the alumina was dispersed in 25 g of DI deionized water and the particle size in the aqueous alumina sol measured. Various amounts of the alumina sol were added to aqueous dispersions (solutions) of LAS which resulted in the formation of the modified alumina floc. The floc was recovered, spray dried using the spray drying technique described above with respect to Example 1 and the dried, modified aluminas redispersed in toluene initially at about 1 to 5% w/w concentration, and the particle size measured on a further diluted sol. While, as seen from the data in Table 2, the particle size (PS) of the alumina in the aqueous sol as compared with the particle size of the modified alumina in the toluene sol varies over wide limits, in all cases, in the concentration range of from 1 to 5% w/w in toluene the mixtures were stable in the sense that there was no settling or agglomeration of the modified aluminas and the toluene sols ranged from being transparent to translucent. More specifically, all of the toluene sols in Tables 1 and 2 had an NTU of less than 1,000 nm.

TABLE 2
Particle Size for Various Alumina/Toluene Sols

| Alumina (oxide) | phase/cryst. size | as-is | SA | LAS added | PS in water | PS in toluene |
|---|---|---|---|---|---|---|
| Dispal 23A4 | small boehmite | 200 | | 1.336 | 123.4 | 374.3 |
| Catapal XBX-14 | large boehmite | 75 | | 0.506 | 172.6 | 524.9 |
| Catapal 200 | large boehmite | 50 | | 0.348 | 227.3 | 642.6 |
| Catapal XBX-4 | large boehmite | 37 | | 0.254 | 353.7 | 539.3 |
| Ceralox APA 0.5G | gamma | 60 | | 0.403 | 532.4 | 241.4 |
| Catapal XO | gamma/delta/theta | 50 | | 0.334 | 309.5 | 214.8 |
| Catapal XO | gamma/delta/theta | 50 | | 0.334 | 297.9 | 210.2 |
| Ceralox APA 0.2 | theta | 40 | | 0.273 | 320.9 | 189.7 |
| | | m²/g | | g | nm | nm |

¹ Marketed by Sasol North America, Inc.
² Surface area

### EXAMPLE 3

This example demonstrates that metal oxides other than alumina can be formed into modified metal oxides which are dispersible in apolar organic solvents such as toluene to form stable sols. The two metal oxides used were a silica-alumina marketed as SIRAL 30D by Sasol Germany GmbH and a colloidal silica marketed as LUDOX AS-30 marketed by E.I. du Pont de Nemours and Company. 10 g of SIRAL 30D was added to 90 g of DI water to form the silica alumina sol. The sol in its entirety was then added to a water solution containing 8.3 g of LAS (8.3% by wt. LAS). In the case of LUDOX AS-30, 34 g of a 30% w/w sol was diluted with 100 g of DI water. The diluted sol was added to an aqueous solution of 3.67 g of LAS (2.7% by wt. LAS). The solids which formed in both cases were recovered and dried as per the conditions in Example 1. The dried powder was then redispersed in toluene. The results are shown in Table 3 below.

TABLE 3
Average Particle Size Measured by Light Scattering and pH Values

| Material | in water | in toluene |
|---|---|---|
| Siral 30D (silica-alumina) | 0.106 (3.6) | 0.344 |
| Ludox AS-30 (colloidal silica) | 0.048 (9.7) | 2.700 |
| | um (pH) | um |

In both cases, once again, while there was significant difference in the particle size of the unmodified metal oxides in the aqueous sols as compared with the toluene sols of the modified metal oxides, the toluene sols were stable in the sense that there was no settling of solids under quiescent conditions.

### EXAMPLE 4

Catipal® alumina was peptized with formic acid to form aqueous sols. In all cases, the aqueous alumina sols contained 12% alumina by wt. 100 g of each of the sols was mixed with 100 g of a solution of an LAS marketed as BIO-SOFT S-101 by Stepan Company. The flocs which formed were spray dried according to the procedure of Example 1 and the spray dried organo modified aluminas were dispersed in various solvents at a 5% wt./wt. level. the average particle size of each sample was determined by light scattering measurements. The results are shown in Table 4 below.

TABLE 4

V1218-31 (toluene) = 79.0 nm
V1218-31 (xylene) = 88.8 nm
V1218-31 (hexane) = 41.8 nm
V1218-31 (pentane) = 51.7 nm
V1218-31 (MEK) = 248.6 nm
V1218-31 (THF) = 114.6 nm
V1218-31 (chloroform) = 112.4 nm
V1218-31 (IPA) = settles
V1218-31 (EtAc) = settles
V1218-31 (acetone) = settles
V1218-31 (MeOH) = settles
V1218-31 (EtOH) = settles
V1218-31 (H2O) = settles

It is apparent from the data in Table 4 that LAS treated alumina gives very small dispersed particle sizes in non-polar solvents but is not dispersible in water or highly polar organics, e.g., alcohols.

It was noted that the untreated alumina, i.e., the initial peptized product of Catapal A and formic acid, has a dispersed particle size in water of approximately 40-50 nm. By comparison, the data in Table 4 shows that the present invention is capable of preventing the irreversible agglomeration of the alumina in water when treated with LAS followed by drying. The spray dried, treated alumina is capable of being redispersed in non-polar organics to roughly the same particle size as in water for the non-treated aluminas.

As can be seen from above data, the method of the present invention produces modified metal oxides which can be dispersed in organic matrices, e.g., apolar organic liquids, to form stable sols in the sense that the modified metal oxides remain dispersed, under quiescent conditions. Additionally, depending on the particular metal oxide and its concentration in the apolar organic liquid, the sol of the modified metal oxide and the apolar organic liquid range from being transparent to translucent, i.e., they generally have NTU values of less than 1,000.

As can be seen from the data above, the invention is characterized by the addition of a well peptized aqueous sol of a metal oxide, e.g., alumina to a solution (dispersion) of an anionic surfactant such as sulfonic acid modifier at ambient temperature with good mixing. Using this mixing order insures an excess of surfactants with respect to the available alumina surface area. It is believed that the surfactant (sulfonic acid modifier) coats and saturates the alumina surface, causing an alumina/surfactant floc to form that settles from the aqueous phase due to thermodynamic incompatibility. Upon reagitation, the floc can be filtered or centrifuged to produce a wet cake that can be oven dried. Alternatively, and more commonly, the suspended floc can be spray dried to produce a fine, dried powder. In either case, the resulting powder can be redispersed in non-polar solvents to produce stable, transparent organo-sols of the metal oxide with dispersed particle sizes similar to those of the starting aqueous metal oxide sols.

Representative but non-limiting applications for the compositions obtained by this process includes catalysts and catalyst supports; coatings; adsorbents; surface treatments; ceramics and refractories; reinforcement of ceramics, metals, plastics and elastomers; scratch resistant coatings; agents for the delivery of pharmaceutically active materials; thickening agents and rheology modifiers; rinse aids; fabric treatment; paper treatment; inkjet recording media; soil resistant coatings; and barrier coatings.

The foregoing description and examples illustrate selected embodiments of the present invention. In light thereof, variations and modifications will be suggested to one skilled in the art, all of which are in the spirit and purview of this invention.

1. A method of preparing a metal oxide which is dispersible in organic matrices comprising:
forming a reaction product mixture by adding an aqueous sol of a metal oxide to an aqueous suspension of a sulfonic acid modifier having the structure
X(SO_{y}M)ₙ
wherein X is an organic moiety, M is a monovalent cation, y is 3 or 4, and n is an integer reflecting the number of —SO_{y}M groups bonded to the organic moiety, to form a modified metal oxide; and
recovering said modified metal oxide from said reaction product mixture.

2. The method of claim 1 wherein said metal oxide is selected from the group consisting of aluminas, aluminum silicate, silicon-aluminum oxides, silicas and mixtures thereof.

3. The method of claim 2 wherein said metal oxide comprises an alumina.

4. The method of claim 1 wherein said mixture is heated to a temperature of from 30 to 170° C.

5. The method of claim 1 wherein the weight ratio of metal oxide, calculated as metal oxide, to sulfonic acid modifier, calculated as X(SO_{y})ₙM, is from 98:2 to 70:30.

6. The method of claim 1 wherein said recovered modified metal oxide is dried at a temperature of from 80 to 120° C.

7. A method of forming a composition comprised of a metal oxide dispersed in an organic matrix comprising:
forming a reaction product mixture by adding an aqueous sol of a metal oxide and to an aqueous suspension of a sulfonic acid modifier having the structure
X(SO_{y}M)ₙ
wherein X is an organic moiety, M is a monovalent cation, y is 3 or 4, and n is an integer reflecting the number of —SO_{y}M groups bonded to the organic moiety to form a modified metal oxide.
recovering said modified metal oxide from said reaction product mixture; and
dispersing said modified metal oxide in said organic matrix.

8. The method of claim 7 wherein said organic matrix is an apolar organic liquid.

9. The method of claim 8 wherein said organic liquid comprises a liquid aromatic compound.

10. The method of claim 7 wherein said modified metal oxide is present in said organic matrix in an amount of from 1 to 40 wt. % based on the combined weight of organic matrix and modified metal oxide.

11. The method of claim 7 wherein said metal oxide is selected from the group consisting of aluminas, aluminum silicate, silicon-aluminum oxides, silicas and mixtures thereof.

12. The method of claim 11 wherein said metal oxide comprises an alumina.

13. The method of claim 7 wherein the weight ratio of metal oxide, calculated as metal oxide to sulfonic acid modifier, calculated as X(SO_{y})ₙM, is from 98:2 to 70:30.

14. The method of claim 7 wherein said recovered modified metal oxide is dried at a temperature of from 80 to 120° C.

15. The method of any of claims 1 or 7 wherein said sulfonic acid modifier has the structure 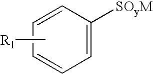
wherein R₁ is an organic moiety having from 7 to 20 carbon atoms, y is 3 or 4 and M is a monovalent cation.

16. The method of claim 16 wherein R1 is an alkyl group.

17. The method of claim 19 wherein R₁ is an alkyl group containing from 10 to 14 carbon atoms.
